(19) United States
(12) Patent Application Publication
(10) Pub. No.: US 2016/0036378 A1
(43) Pub. Date: Feb. 4, 2016

(54) HYBRID PHOTOVOLTATIC AND PHOTO-THERMAL SOLAR PANEL

(71) Applicant: Bruce Lloyd GRAY, Abbotsford (CA)

(72) Inventor: Bruce Lloyd GRAY, Abbotsford (CA)

(21) Appl. No.: 14/449,122

(22) Filed: Jul. 31, 2014

(51) Int. Cl. H02S 40/44

(52) U.S. Cl. CPC H02S 40/44

(57) ABSTRACT

A hybrid photovoltaic/photo-thermal panel has at least one photovoltaic cell mounted on and in thermally conductive communication with an evaporator, the evaporator being a single piece of thermally conductive material having a first outer surface configured for mounting photovoltaic cells thereon, an uninsulated second outer surface exposed to ambient air and the single piece of thermally conductive material having fluid flow channels formed therein configured to permit flow of refrigerant from at least one fluid inlet to at least one fluid outlet in the evaporator. Heat generated by the at least one photovoltaic cell or from the ambient energy of the surrounding air or other source of heat is absorbed by the refrigerant. The panel may be part of a system including a compressor for circulating refrigerant through the channels and a condenser for extracting heat from the refrigerant. The hybrid system has an increased coefficient of performance for utilizing full spectrum solar energy for both power and heating, plus environmental energy heating during poor or non-existent light conditions.

### FIELD

This application relates to solar panels, systems comprising solar panels and methods of making solar panels, in particular to solar panels for both photovoltaic and photo-thermal applications.

### BACKGROUND

Photo-thermal and photoelectric are the two basic ways of converting solar energy into useable energy. In the first, a fluid is heated in a collector (e.g. a system of light-absorbing tubes) to a high temperature and the heated fluid is used for a variety of purposes including space heating, heating water in a water tank, heating water in a swimming pool, etc. In the second, arrays of photovoltaic cells directly convert solar energy into electricity in the form of direct current, which is used to power various devices.

Both photo-thermal and photovoltaic methods are relatively inefficient at converting solar energy into useable energy. Efforts have been made to combine photo-thermal and photovoltaic methods to increase the coefficient of performance of utilizing solar energy. For example U.S. Pat. No. 8,667,806 issued March 11, 2014, describes a system in which electricity from photovoltaic cells is used to power a heat pump, but such methods have only provided marginal increases in the coefficient of performance. Further, efforts have been made to cool photovoltaic panels to improve electrical generation efficiency of the photovoltaic cells (e.g. United States Patent Publication US 2013/0036752 published Feb. 14, 2013 and EP 2262004 published Dec. 15, 2011), but such efforts do not efficiently utilize full spectrum light to integrate photovoltaic power generation with photo-thermal techniques.

There remains a need for improved solar panels and systems that increase the overall coefficient of performance of utilizing solar energy.

### SUMMARY

In one aspect of the invention there is provided a hybrid photovoltaic/photo-thermal panel comprising at least one photovoltaic cell mounted on and in thermally conductive communication with an evaporator, the evaporator comprising a single piece of thermally conductive material having a first outer surface configured for mounting photovoltaic cells thereon, an uninsulated second outer surface exposed to ambient air and fluid flow channels formed in the single piece of thermally conductive material configured to permit flow of refrigerant from at least one fluid inlet to at least one fluid outlet in the evaporator.

In another aspect of the invention there is provided a hybrid photovoltaic/photo-thermal system comprising: a panel as described above; a compressor configured to raise a temperature and pressure of the refrigerant; a condenser configured to receive refrigerant from the compressor and extract heat therefrom, thereby lowering the temperature of the refrigerant; an expansion valve configured to receive refrigerant from the condenser and lower a pressure thereof; and, a plurality of fluid conduits configured to permit flow of the refrigerant from the at least one fluid flow outlet of the evaporator to the compressor, from the compressor to the condenser, from the condenser to the expansion valve, and from the expansion valve to the at least one fluid flow inlet of the evaporator, the compressor further configured to circulate refrigerant through the fluid conduits and the fluid flow channels.

In yet another aspect of the invention, there is provided a method of capturing solar energy comprising: converting solar energy into electrical energy with a photovoltaic cell mounted on and in thermally conductive communication with an evaporator, the evaporator comprising an uninsulated outer surface exposed to ambient air, the uninsulated outer surface absorbing heat; cooling the evaporator with a flow of refrigerant through channels in the evaporator, the cooling of the evaporator causing cooling of the photovoltaic cell through conduction of heat from the photovoltaic cell to the evaporator, the cooling of the evaporator causing heating of the refrigerant; and, extracting the heat from the refrigerant in a heat exchanger to utilize the heat in a further application.

It has now been found that a significant increase in the overall coefficient of performance of utilizing solar energy may be obtained in a photo-conversion system by mounting the photovoltaic cell directly on an evaporator, cooling the evaporator with refrigerant flowing through the evaporator, and hence cooling the photovoltaic cell, and recovering absorbed heat from the refrigerant. Recovering heat generated from the photovoltaics, and from direct illumination of the evaporator by solar energy, results in increased photovoltaic electricity production and permits using the recovered heat for another purpose (e.g. water heating or space heating). In this way, coefficient of performance is significantly improved. Greater heat transfer from the photovoltaics to the refrigerant may be accomplished by circulating refrigerant through an evaporator on which the photovoltaic cell is mounted than by simply passing ambient or cooled air behind a photovoltaic panel.

Further, the present invention may combine the benefits of solar photovoltaic electricity generation, solar thermal heat generation, heat exchangers and heat pumps to provide a more efficient solution for electricity, heating and cooling needs in building in any season. Such a combination expands energy options as a system based on the present invention is not limited to peak solar radiation, functions in all weather, is less subject to damage from freezing, boiling and fouling and may utilize only a single moving part, i.e. a compressor for circulating refrigerant.

Because the present invention is not limited to peak solar radiation, it is not limited to the typical ¼ day of direct sunlight on the panel, but instead is able to conduct full day heat exchange using refrigerant as a much colder fluid to absorb environmental and ambient energy even in complete darkness of night. Adding ¾ of each day (18 hours) allows this invention to function as a primary heat source, being able to supply thermal energy on demand day and night. Being able to produce thermal energy on demand is a superior alternative to energy storage during the 6 hours for use in the following 18 hours or longer.

A photovoltaic cell is an electrical device that converts the energy of light directly into electricity by the photovoltaic effect. A photovoltaic cell is a device whose electrical characteristics (e.g. current, voltage, resistance) vary when exposed to light. In a photovoltaic cell, photons in light impinge the cell and are absorbed by one or more semiconducting materials. Electrons are excited from their current molecular/atomic orbital in the material and once excited an electron can dissipate the energy as generated heat and return to its orbital, or the electron can travel through the cell until it reaches an electrode. Current flows through the material to cancel the potential and this electricity is captured. A plurality of photovoltaic cells may be arranged in an array and electrically connected so that the array converts light energy into a usable amount of direct current (DC) electricity. An inverter may be used to convert the direct current to alternating current (AC). A photovoltaic cell comprises one or more semiconducting materials, for example monocrystalline silicon although any appropriate semiconducting material may be used. A photovoltaic cell made from a semiconducting wafer may also comprise a conducting contact grid made from bus bars (larger strips) and fingers (smaller strips) to carry electricity. An array comprising a plurality of photovoltaic cells may be encapsulated as a module in which a sheet of transparent material (e.g. glass) on the light-facing side allows light to pass while protecting the semiconductor wafers. Photovoltaic cells in the array may be electrically connected in series in modules creating an additive voltage, or may be connected in parallel to yield higher current.

The at least one photovoltaic cell is mounted on and in thermally conductive communication with an evaporator. Preferably, a plurality of photovoltaic cells is mounted as an array on the evaporator. The evaporator in effect replaces the support panel of a typical solar panel thereby creating a hybrid photovoltaic/photo-thermal panel. Thermal contact of the photovoltaic cells with the evaporator is maximized by mounting a substantially flat back side of the cells on a substantially flat first outer surface of the evaporator so that the cells are in direct contact with the evaporator over as large a surface area as is practical. In one embodiment, the first outer surface of the evaporator configured for mounting photovoltaic cells is sufficiently flat so that each of the photovoltaic cells is contact with the first outer surface over an entire area of a back side of the photovoltaic cell. Heat generated by the at least one photovoltaic cell may be transmitted by conduction to the piece of thermally conductive material, the piece of thermally conductive material transmitting heat by conduction to the refrigerant in the fluid flow channels. In addition to heat transfer by conduction, heat is also transferred from the at least one photovoltaic cell to the piece of thermally conductive material by convection and/or radiation. Maximizing physical contact between the at least one photovoltaic cell and the piece of thermally conductive material is preferred as such maximization of contact maximizes heat transfer by conduction.

The evaporator comprises a single piece of thermally conductive material. The material is preferably a metal, for example, aluminum, aluminum alloy, steel, copper, graphite, graphene and the like, more preferably a low density material. The thermally conductive material more preferably comprises aluminum or an aluminum alloy. The fluid flow channels in the evaporator may be entirely enclosed within the single piece of metal, except for at least one opening corresponding to the at least one fluid inlet and at least one other opening corresponding to the at least one fluid outlet. The fluid flow channels may be integrally molded in the single piece of thermally conductive material.

The single piece of thermally conductive material may be a monolithic, preferably comprising no seams bolts, welds, adhesives or other connections used to join parts of a typical evaporator. Seamlessness by roll-bonding using large surface fusion or 3-D printing, and the lack of bolts, welds, adhesives or other connectors provides a significant advantage including one or more of enhanced thermal contact between the evaporator and the photovoltaic cells leading to enhanced thermal transfer, more uniform thermal profile across the evaporator with less temperature variation from one area to another of the evaporator, complete seal to prevent leaks of refrigerant and resistance to the formation of leaks because there are no connectors to fail as the panel ages from expansion, corrosion or high pressure fatigue.

The single piece of thermally conductive material may be formed by an appropriate forming technique for the type of material. For example, metal materials may be formed by roll bonding two metal sheets, one of which has a channel trace patterned thereon, and the channels inflated within the metal after roll bonding. The forming techniques provide the ability to create any configuration of channels, manifolds and hydraulic balancing chambers inside the thermally conductive material to optimize heat transfer and refrigerant evaporation. Panels are inexpensive and may be reliably formed with a flat first outer surface for directly mounting photovoltaic cells. Manufacturing is consistent and may be automated to eliminate or reduce variance in the product.

The fluid flow channels form an interconnected pattern that may be configured to permit distribution of the refrigerant throughout the evaporator to contribute to uniform cooling of the at least one photovoltaic cell. For example, harp-style or serpentine, preferably harp-style, patterns may be used. A harp-style hydraulic pattern is preferred for narrow temperature gradients and improved thermal transfer. The refrigerant may be circulated through the channels as a gas or vapor, with relatively cold gas entering the channels at the fluid inlet and hotter gas exiting the channels at the fluid outlet. Alternatively, liquid refrigerant may enter the channels at the inlet and the fluid flow channels may be configured to permit vaporization of at least a portion of the liquid refrigerant in the evaporator. Preferably, all or most of the liquid refrigerant is evaporated in the evaporator. Configuring the channels to permit vaporization of at least a portion of the liquid refrigerant may involve an uneven or non-symmetrical pattern of channels. An important purpose of the hybrid photovoltaic/photo-thermal panel is to provide photo-thermal heating capacity; therefore, the evaporator is preferably designed to be an efficient heat exchanger that increases temperature of cold liquid refrigerant entering the evaporator to such a temperature that the refrigerant evaporates in the channels in the evaporator. Utilizing the heat of vaporization of the refrigerant is an important factor in efficient heat exchange. Thus, a channel design that leaves sufficient volume for refrigerant vaporization within the channels is preferred.

The evaporator comprises at least one fluid inlet configured to permit flow of liquid or gaseous refrigerant into the channels in the evaporator. The evaporator comprises at least one fluid outlet configured to permit flow of refrigerant, for example hot refrigerant vapour and any excess liquid refrigerant, out of the evaporator. More than one fluid inlet and/or more than one fluid outlet may be present, although one fluid inlet and one fluid outlet is preferable. The refrigerant may be any suitable refrigerant, for example, refrigerants known in the heating and cooling arts such as R410a, R744 or others. R410a is an approved refrigerant used now. R744 is a natural refrigerant comprising CO₂, which has improved performance but at higher pressure. Preferred refrigerants have a large heat of vaporization and a liquid/gas phase change at a temperature and pressure that can be relatively easily attained inside the channels of the evaporator.

The evaporator comprises an uninsulated second outer surface exposed to ambient air. Exposing the second outer surface to ambient air is an important aspect of the photo-thermal aspect of the hybrid photovoltaic/photo-thermal panel. Although the refrigerant acts to cool the photovoltaic cells, another equally important aspect is for the refrigerant to be heated to a high temperature. It is desirable to have a large increase in the temperature of the refrigerant from where the refrigerant first enters the evaporator at the fluid inlet to where the refrigerant exits the evaporator at the fluid outlet. A large temperature differential implies greater collection of heat, increasing the amount of heat available to be extracted at the condenser that can be utilized for other purposes. Similarly, in extracting the heat from the refrigerant at the condenser and any additional heat exchangers that are provided, it is desirable to have a large decrease in the temperature of the refrigerant from where the refrigerant first exits the evaporator at the fluid outlet to where the refrigerant enters the evaporator at the fluid inlet.

In the present hybrid photovoltaic/photo-thermal system, the evaporator is separated from the condenser and compressor and integrated into a hybrid photovoltaic/photo-thermal panel. The system comprises the hybrid photovoltaic/photo-thermal panel, a separate condenser, a compressor, an expansion valve, fluid flow conduits to complete a refrigerant cycle from the outlet of the evaporator to the inlet of the condenser and from the outlet of the condenser to the inlet of the evaporator, and means for circulating refrigerant through the fluid flow channels and fluid conduits, which may comprise the compressor and, if refrigerant is condensed to a liquid, optionally one or more pumps.

The means for circulating refrigerant preferably comprises a compressor between the at least one fluid flow outlet and the condenser. The compressor may be configured to compress refrigerant vapor exiting the hybrid photovoltaic evaporator and thereby raise temperature of the refrigerant vapor. The means for circulating refrigerant may be powered by electricity. At least a portion of the electricity may be received from a photovoltaic array, for example the array of photovoltaic cells mounted on the evaporator. Alternatively or in addition, electricity may be provided by a different photovoltaic panel or a different source of electricity altogether. In one embodiment, DC voltage from a photovoltaic panel directly powers a DC motor compressor without the requirement for an AC inverter or the resulting power conversion losses.

Hot refrigerant passes through the condenser, which lowers the temperature of the refrigerant and/or condenses refrigerant vapor in the at least one fluid conduit. Refrigerant may be a liquid or remain a vapor once leaving the condenser. The system may be configured to use the heat extracted by the condenser to heat water and/or air, which is preferably accomplished by passing the water and air through condenser coils in thermal contact with the hot refrigerant in the at least one fluid conduit. Water heated in this manner may be used for any desired purpose, for example domestic hot water heating, a swimming pool or a spa. Air heated in this manner may be used for any desired purpose, for example space heating, drying or waste heat dissipation. The system may comprise one or more additional heat exchangers other than the condenser described above.

An expansion valve may be located between the condenser and the at least one fluid flow inlet of the evaporator. The expansion valve helps further lower the temperature of the refrigerant and/or condense the refrigerant vapor (if so desired) in the at least one fluid conduit. Fluid conduits may comprise any suitable material, for example metals and plastics, copper piping being particularly preferred.

The system may further comprise a control system for controlling various aspects including the compressor and/or any additional systems linked to the hybrid photovoltaic/photo-thermal system. The control system may comprise various controllers, for example switches (manual or electronic), valves (manual or electronic), sensors, etc. Controllers may be programmable with software to respond to certain conditions. Controllers include all of the necessary hardware for their functioning including any electronic memory devices and electronic communication devices. In one embodiment, the system may comprise a frost protection system comprising a controller, a frost sensor in communication with the controller configured to sense a temperature of the evaporator and a reversing valve for directing refrigerant to a heat collector configured to supply waste heat from the compressor to the refrigerant, the frost protection system configured to provide the waste heat in the refrigerant to the evaporator in order to prevent frost accumulation on the evaporator.

In another embodiment, system sensors may be configured to detect when a building's occupant is absent, which signals the system to reduce heating or cooling thereby saving energy. Conversely, system sensors may be configured to detect when the occupant returns to the building, which signals the system to increase heating or cooling to increase comfort level. Such signaling may be linked to the occupant's vehicle so that upon entering the vehicle, the occupant or automatic sensors can initiate resumption of climate control adjustment to time reaching optimal comfort level in the building to coincide with the occupant's return.

The hybrid photovoltaic/photo-thermal system may serve as a primary solar heating system, effectively replacing the need for a boiler or furnace system. It may have an integrated electric tankless heater that is controlled to supply backup heat in the event that the available heat from the evaporator is insufficient to meet overall demand. In contrast, prior art solar systems have generally been considered supplemental in respect of a separate primary heating system. Photo-thermal heat production at the first flat side of the evaporator and heat absorbed from ambient air by the second uninsulated side of the evaporator provides two sources of heat, which can provide up to all of the heating loads required in a domestic or light commercial environment, even at night. Further, the hybrid photovoltaic/photo-thermal panel is capable of capturing energy from full spectrum light, including infrared, which might otherwise not be utilized by the photovoltaic. Thus, the evaporator on which the photovoltaic cells are mounted is configured to utilize the light energy not utilized by the photovoltaic cells. Furthermore, the hybrid photovoltaic/photo-thermal system has the ability to perform both heating and cooling when configured with heat exchange to a sufficiently large heat sink, which increases the flexibility of the system under any environmental conditions. Heating and cooling may be performed simultaneously, and with control over priorities, so during summer air conditioning use, the waste heat can be utilized for hot water storage or a pool to offset other energy and double the efficiency.

A plurality of hybrid photovoltaic/photo-thermal panels of the present invention may be arranged to form an array of panels, each panel comprising an array of photovoltaic cells mounted on an evaporator. The plurality of panels may comprise 2, 3, 4, 5, 6 or more panels. A particularly preferred array of panels comprises 2 panels. The fluid inlets and fluid outlets of the evaporators may be in fluid communication with fluid conduits, the fluid conduits providing liquid refrigerant to the fluid inlets of each evaporator and carrying away refrigerant vapor and any excess liquid refrigerant from the fluid outlets of each evaporator. Any suitable arrangement of fluid conduits may be used. The fluid conduits are preferably arranged so that refrigerant may be recirculated through the evaporators in a closed loop. Preferably, the panels are arranged in parallel so that liquid refrigerant coming from the condenser is split into separate fluid conduits to provide liquid refrigerant to each fluid outlet, and so that refrigerant vapor exits the fluid outlets into separate fluid conduits, which are then combined into a single fluid conduit to transport the vapor to the compressor. Such an arrangement improves efficiency of heat capture in the system.

Preferably, the panels in the array of panels are further configured so that the fluid inlets of each evaporator are located below the fluid outlets of each evaporator in the array. Where the fluid inlet of each panel is at an opposite end of the panel from the fluid outlet of each panel, the panels in the array may all be of the same channel design and may be arranged side-by-side with the fluid inlets at the bottom end and the fluid outlets at the top end. Where the fluid inlets of each panel and the fluid outlets of each panel are on the same end of the panel, the panels may be arranged so that the ends point sideways and the fluid inlets and outlets of two neighboring panels point at each other. In such an arrangement where the panels have the fluid inlets and fluid outlets on the same end, it is preferable to have left hand and right hand panels where the channel design in the right hand panel is a mirror image of the channel design in the left hand panel. Having a right hand panel next to a left hand panel with fluid inlets and outlets pointing at the neighboring panel would then result in both of the fluid outlets being higher than both of the fluid inlets, which provides a fluid flow advantage by simplifying fluid conduit design.

The fluid inlets and fluid outlets preferably have different size fittings. Different size fittings prevent connecting a fluid inlet of one panel to a fluid outlet of another panel, which would result in less than optimal fluid flow. Further, in constructing an array of panels, it is preferable that fluid pressure to each panels is equalized, which may be accomplished by having a balanced fluid conduit manifold that supplies liquid refrigerant equally to each evaporator. For this reason, it is preferable to construct elements of fluid conduit manifolds off-site in a controlled environment using standard size conduits and quick-fit locking fittings, thereby permitting rapid and consistent assembly of a balanced fluid conduit manifold without the need for cutting, welding and brazing fluid conduits and fittings on-site. This has the further advantage of reducing nicks, scratches and other damage to fluid conduits, which reduces the potential for leaks.

Further features will be described or will become apparent in the course of the following detailed description. It should be understood that each feature described herein may be utilized in any combination with any one or more of the other described features, and that each feature does not necessarily rely on the presence of another feature except where evident to one of skill in the art.

### BRIEF DESCRIPTION OF THE DRAWINGS

For clearer understanding, preferred embodiments will now be described in detail by way of example, with reference to the accompanying drawings, in which:

FIG. 1A is an end view of a hybrid photovoltaic/photo-thermal panel taken from an inlet end;

FIG. 1B is an end view of the hybrid photovoltaic/photo-thermal panel of FIG. 1A taken from an outlet end;

FIG. 1C is an end cross-sectional view of the hybrid photovoltaic/photo-thermal panel of FIG. 1A taken proximate the inlet end of the panel;

FIG. 1D is a top plan view of the hybrid photovoltaic/photo-thermal panel of FIG. 1A showing how a first variation of a pattern of channels on a bottom side would align with an array of photovoltaic cells;

FIG. 1E is a bottom plan view of the hybrid photovoltaic/photo-thermal panel of FIG. 1A showing a second variation of a pattern of channels;

FIG. 1F is a bottom perspective view of the hybrid photovoltaic/photo-thermal panel of FIG. 1A showing a third variation of a pattern of channels; and,

FIG. 2 is a schematic diagram of a hybrid photovoltaic/photo-thermal system showing two hybrid photovoltaic/photo-thermal panels of FIG. 1A in conjunction with a compressor and a condenser.

### DETAILED DESCRIPTION

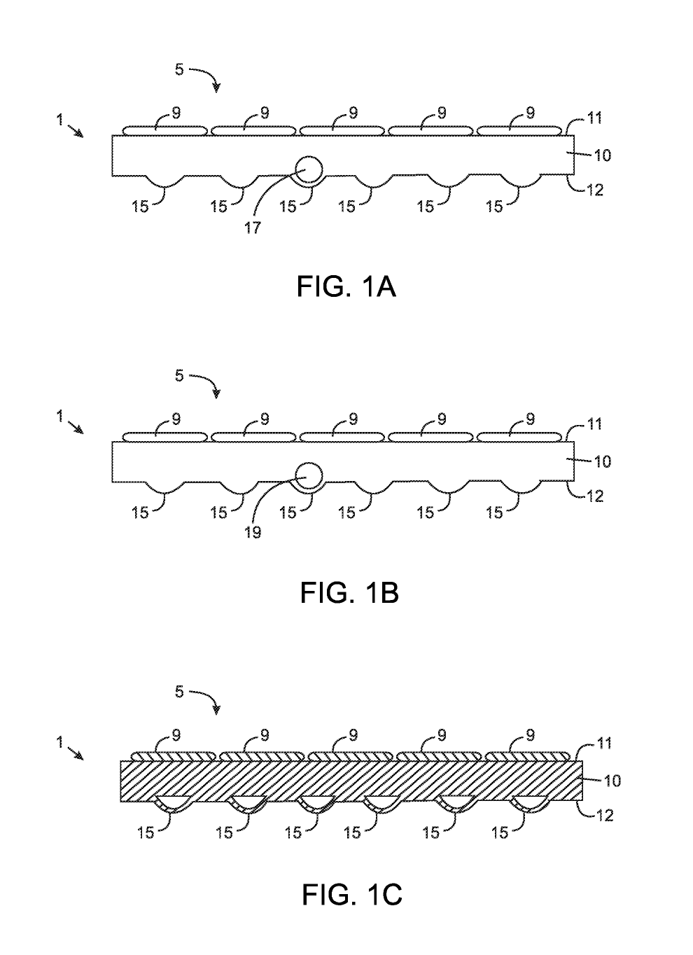

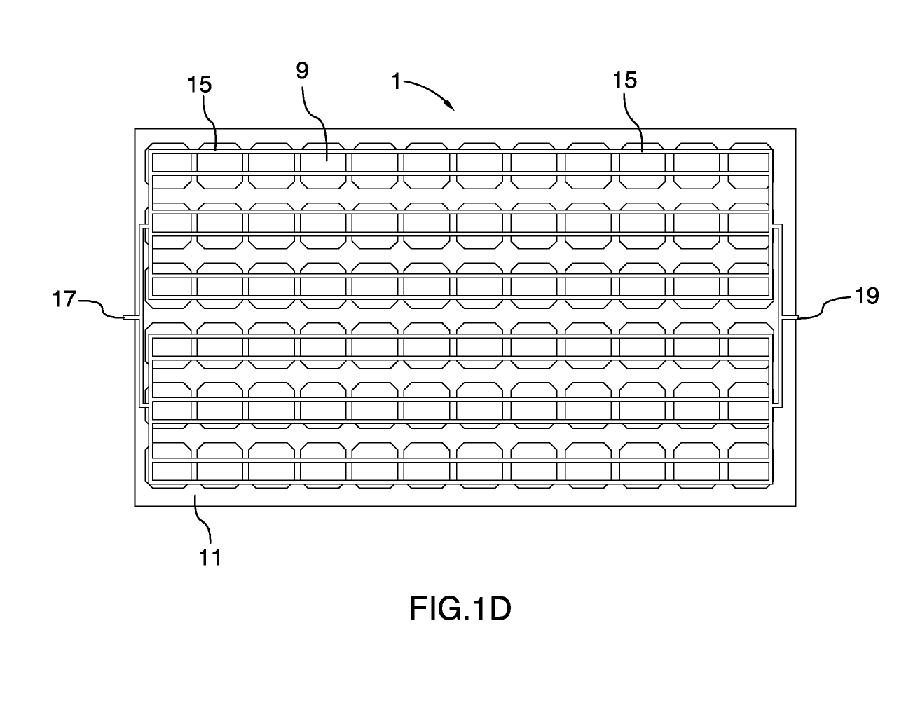

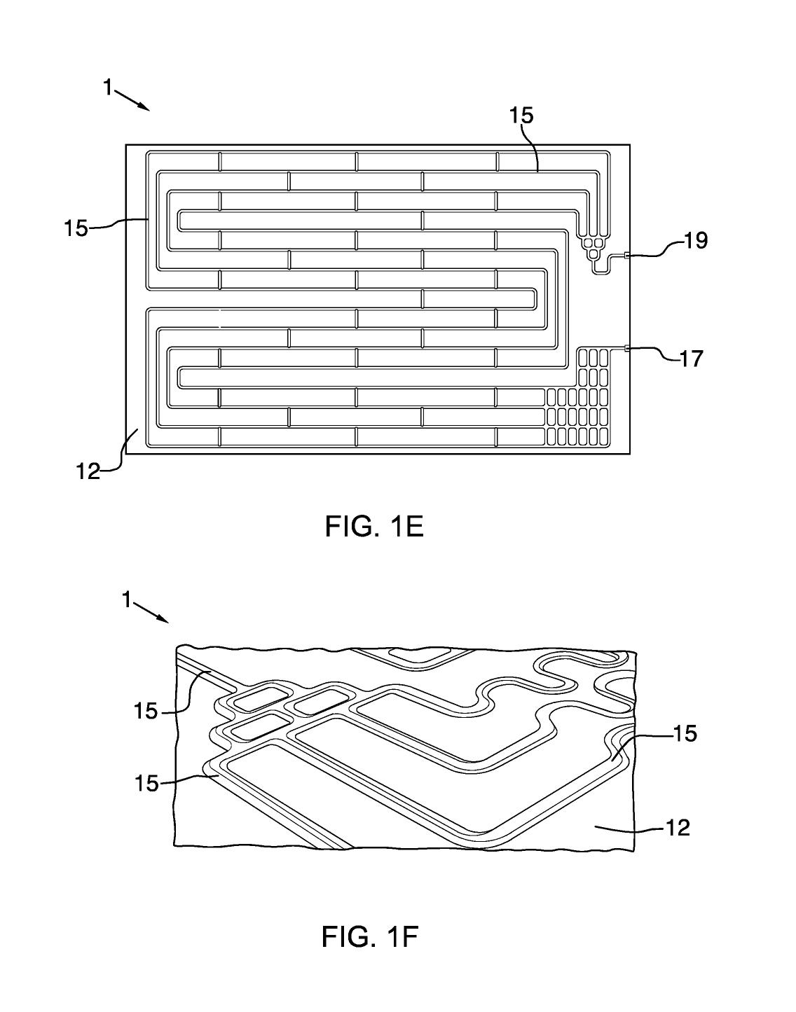

FIGS. 1A-1F depict a hybrid photovoltaic/photo-thermal panel 1 comprising an array 5 of photovoltaic cells 9 mounted on a flat first side 11 of an evaporator 10. The evaporator 10 comprises a single, monolithic piece of aluminum having fluid flow channels 15 formed therein by a roll bond forming method. The channels 15 form protrusions in the aluminum on an uninsulated second side 12 of the evaporator 10. A fluid inlet 17 is formed into a first end of the evaporator 10 and a fluid outlet 19 is formed into a second end of the evaporator 10, although the inlet and outlet may be located anywhere on the evaporator. The inlet 17 and outlet 19 are in fluid communication with each other through the channels 15. The channels 15 are wholly within the piece of aluminum and communicate with an outside environment only through the inlet 17 and outlet 19. The channels 15 form an interconnected web throughout the evaporator 10. FIG. 1 D shows a first variation of a pattern of channels 15 that may be formed in the aluminum. The channels 15 in FIG. 1D are on the other side of the evaporator 10 from the photovoltaic cells 9, but are included in FIG. 1D to illustrate how they align with the photovoltaic cells 9. The pattern formed by the channels 15 in FIG. 1D is a harp-like pattern. FIG. 1E shows a second variation of a pattern of channels 15 that may be formed in the aluminum and FIG. 1F shows a part of another variation of a pattern of channels 15 that may be formed into the aluminum. In both FIG. 1E and FIG. 1F, the channels form a serpentine pattern.

The channels 15 permit refrigerant to be distributed throughout a substantial portion of the evaporator thereby providing efficient cooling over the whole of the panel. The photovoltaic cells 9 are mounted on the flat side 11 of the evaporator 10 in a manner to maximize thermal contact between the photovoltaic cells 9 and the piece of aluminum. Since the evaporator 10 comprises a monolithic piece of aluminum, there are no seams, welds, bolts or other thermal barriers to interrupt conduction of heat between the photovoltaic cells 9 and the evaporator 10, which increases the coefficient of performance even greater. Further, the array 5 of photovoltaic cells 9 is cooled relatively evenly by the refrigerant flowing through the channels 15, which maximizes photovoltaic performance of the photovoltaic cells 9 across the array 5. The large coefficient of thermal conductivity for aluminum contributes to efficient cooling of the photovoltaic cells 9 mounted on the evaporator 10. The thermal conductivity may be improved with thermal conductive coatings like titanium oxide or other enhancements.

The uninsulated second side 12 of the evaporator 10 is exposed to ambient air and therefore further absorbs heat from the atmosphere to enhance heating of the refrigerant and encourage vaporization of the refrigerant in the channels 15. Light shining on the evaporator 10 on both the uninsulated second side 12 and on the flat first side 11 further heats the refrigerant providing more heat to be extracted once the refrigerant is circulated through a condenser as described below.

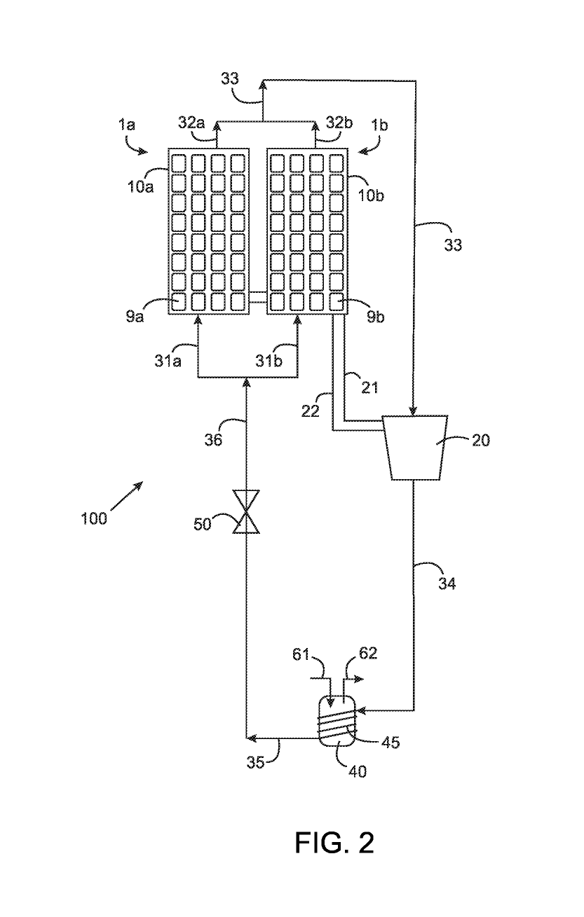

One or more of the hybrid photovoltaic/photo-thermal panels may be included in a hybrid photovoltaic/photo-thermal system 100. As depicted in FIG. 2, two hybrid photovoltaic/photo-thermal panels 1a, 1b of the form described above are included in a fluid refrigerant path comprising the two hybrid photovoltaic/photo-thermal panels 1a, 1b, a compressor 20 and a condenser 40. Cooled, preferably liquid, refrigerant enters the evaporators 10a, 10b of the panels 1a, 1b, respectively, through respective inlets (not shown) from fluid conduits 31a, 31b, respectively. The cooled refrigerant in the evaporators 10a, 10b absorbs heat generated by the photovoltaic cells 9a, 9b (only one each labeled) and heat absorbed by the evaporators 10a, 10b from any solar energy impinging directly on the evaporators 10a, 10b. Refrigerant in the channels of the evaporators 10a, 10b gets hot, and the preferably evaporates within the channels thereby absorbing yet more heat to fuel the evaporation process. The channels in the evaporators are therefore preferably configured to permit at least a portion of the refrigerant to evaporate therein, preferably substantially all the refrigerant being vaporized.

Heated and at least partially vaporized refrigerant leaves the evaporators 10a, 10b through respective outlets (not shown) and is carried away by fluid conduits 32a, 32b, respectively, to be combined into a single conduit 33. Refrigerant in conduit 33 is compressed and forced by the compressor 20 through fluid conduit 34 to be transported to a condenser coil 45 of the condenser 40. Hot refrigerant in the condenser coil 45 is cooled by heat exchange with relatively cool fluid (e.g. air or water) being carried into the condenser 40 through line 61. The relatively cool fluid may be, for example, part of a water supply system for a home water heater or a swimming pool or may be part of an air circulation system for home heating. Any number of other uses for the heat in the refrigerant may be conceived by one skilled in the art, with the condenser 40 acting as the heat exchanger to extract the heat. Heated water or air leaves the condenser through line 62, while cooled and refrigerant leaves the condenser coil 45 through fluid conduit 35. Cooled refrigerant in fluid conduit 35 is passed through an expansion valve 50 for further cooling and preferably condensing, then transported back through fluid conduit 36 to fluid conduits 31a, 31b completing the cycle.

Direct current (DC) produced by the photovoltaic cells 9 is collected and transmitted to an electrical grid for utilization. Part of the DC current may be directed to the compressor 20 through electrical transmission lines 21, 22 to power the compressor. Alternatively or in addition, the compressor 20 may be powered by a different source of electricity.

The entire system 100 may form part of an overall heating/cooling/power system of an installation, for example a building (e.g. a house).

The novel features will become apparent to those of skill in the art upon examination of the description. It should be understood, however, that the scope of the claims should not be limited by the embodiments, but should be given the broadest interpretation consistent with the wording of the claims and the specification as a whole.

1. A hybrid photovoltaic/photo-thermal panel comprising at least one photovoltaic cell mounted on and in thermally conductive communication with an evaporator, the evaporator comprising a single piece of thermally conductive material having a first outer surface configured for mounting photovoltaic cells thereon, an uninsulated second outer surface exposed to ambient air and fluid flow channels formed in the single piece of thermally conductive material configured to permit flow of refrigerant from at least one fluid inlet to at least one fluid outlet in the evaporator.

2. The panel according to claim 1, wherein the thermally conductive material comprises aluminum or aluminum alloy.

3. The panel according claim 1, wherein the single piece of thermally conductive material is seamless and the channels are entirely enclosed within the single piece of thermally conductive material except for at least one opening corresponding to the at least one fluid inlet and at least one other opening corresponding to the at least one fluid outlet.

4. The panel according to claim 1, wherein the first outer surface configured for mounting photovoltaic cells is sufficiently flat that each of the photovoltaic cells is in contact with the first outer surface of the evaporator over an entire area of a back side of the photovoltaic cell.

5. The panel according to claim 1, wherein the channels form an interconnected pattern configured to permit distribution of the refrigerant throughout the evaporator to contribute to uniform cooling of the at least one photovoltaic cell.

6. The panel according to claim 1, wherein the at least one photovoltaic cell generates heat and is configured to transmit the heat by conduction to the piece of thermally conductive material, the piece of thermally conductive material transmitting heat by conduction to the refrigerant in the channels.

7. The panel according to claim 1, wherein the at least one fluid inlet is configured to permit flow of liquid refrigerant into the channels in the evaporator, the channels are configured to permit vaporization of at least a portion of the liquid refrigerant in the evaporator, and the at least one fluid outlet is configured to permit flow of vaporized refrigerant and excess liquid refrigerant out of the evaporator.

8. The panel according to claim 1, wherein the at least one photovoltaic cell comprises an array of photovoltaic wafers.

9. A hybrid photovoltaic/photo-thermal system comprising:
a panel as defined in claim 1;
a compressor configured to raise a temperature and pressure of the refrigerant;
a condenser configured to receive refrigerant from the compressor and extract heat therefrom, thereby lowering the temperature of the refrigerant;
an expansion valve configured to receive refrigerant from the condenser and lower a pressure thereof; and,
and a plurality of fluid conduits configured to permit flow of the refrigerant from the at least one fluid flow outlet of the evaporator to the compressor, from the compressor to the condenser, from the condenser to the expansion valve, and from the expansion valve to the at least one fluid flow inlet of the evaporator, the compressor further configured to circulate refrigerant through the fluid conduits and the fluid flow channels.

10. The system according to claim 9, wherein the condenser lowers temperature of the refrigerant sufficiently to condense refrigerant vapor.

11. The system according to claim 9, wherein the compressor is powered by electricity and receives at least a portion of the electricity from a photovoltaic array.

12. The system according to claim 9, further comprising a controller, a frost sensor configured to sense a temperature of the evaporator, a reversing valve and fluid heating conduits configured to cause the refrigerant to absorb waste heat from the compressor, the reversing valve configured to supply the waste heat from the compressor to the evaporator to prevent frost accumulation thereon.

13. The system according to claim 9, wherein the system is configured to use the heat extracted by the condenser to heat water.

14. The system according to claim 9, wherein the system is configured to use the heat extracted by the condenser to heat air.

15. The system according to claim 9, wherein the system is configured to use the heat extracted by the condenser to heat both water and air.

16. The system according to claim 13, wherein the water is for domestic hot water heating, a swimming pool or a spa.

17. The system according to claim 13, wherein the water is for space heating or cooling.

18. The system according to claim 14, wherein the air is for space heating, cooling, drying or waste heat dissipation.

19. The system according to claim 9, further comprising one or more heat exchangers.

20. A method of capturing solar energy comprising:
converting solar energy into electrical energy with a photovoltaic cell mounted on and in thermally conductive communication with an evaporator, the evaporator comprising an uninsulated outer surface exposed to ambient air, the uninsulated outer surface absorbing heat; cooling the evaporator with a flow of refrigerant through channels in the evaporator, the cooling of the evaporator causing cooling of the photovoltaic cell through conduction of heat from the photovoltaic cell to the evaporator, the cooling of the evaporator causing heating of the refrigerant; and,
extracting the heat from the refrigerant in a heat exchanger to utilize the heat in a further application.
